(19) United States
(12) Patent Application Publication
(10) Pub. No.: US 2013/0325480 A1
(43) Pub. Date: Dec. 5, 2013

(54) REMOTE CONTROLLER AND CONTROL METHOD THEREOF

(71) Applicants: Yin-Ting Lee, Hsin-Chu (TW); Chien-Hung Chen, Hsin-Chu (TW); Chang-Ho Shen, Hsin-Chu (TW)

(72) Inventors: Yin-Ting Lee, Hsin-Chu (TW); Chien-Hung Chen, Hsin-Chu (TW); Chang-Ho Shen, Hsin-Chu (TW)

(73) Assignee: AU OPTRONICS CORP., Hsin-Chu (TW)

(21) Appl. No.: 13/612,856

(22) Filed: Sep. 13, 2012

(30) Foreign Application Priority Data
May 30, 2012 (TW) 101119268

(51) Int. Cl. G10L 21/00

(52) U.S. Cl. 704/275; 704/E11.001

(57) ABSTRACT

A remote controller includes a housing, a direction sensor, a microphone, a controller, and a wireless transmitter. A control method of the remote controller includes detecting an angle between an axis of a remote controller and a vertical axis, enabling a microphone of the remote controller when the angle is within a predetermined range in order to generate a voice signal according to a voice command, and generating a first control signal according the voice signal and transmit the first control signal wirelessly.

### BACKGROUND OF THE INVENTION

1. Field of the Invention

The invention is related to a remote controller, and more particularly, to a remote controller having a voice control mode.

2. Description of the Prior Art

Most remote controllers receive commands from users through signals generated by keys on the remote controllers. As more and more home appliances with new functions are being used in our daily life, it is necessary to dispose more keys on remote controllers for generating new commands to control these new functions. However disposing too many keys on remote controllers tends to confuse users and increase the probability of pressing wrong keys. Furthermore, due to limited sizes of remote controllers, it becomes more and more difficult to dispose an increasing amount of keys on a single remote controller without sacrificing a reasonable and practical dimension for each individual key.

As voice control technology advances over the years, many devices which can be controlled by voice are showing up. These kind of devices range from mobile phones, automobile electronics, navigational devices, etc. It is expected that voice control technology will be applied to various home appliances in the near future.

Improving remote controllers having only keys for receiving commands is essential. Otherwise it is inconvenient that users have to take time to find specific keys on remote controllers before inputting corresponding commands.

### SUMMARY OF THE INVENTION

An embodiment of the present invention discloses a remote controller. The remote controller includes a housing, a direction sensor, a microphone, a controller, and a wireless transmitter. The direction sensor is for detecting an angle between an axis of the housing and a vertical axis. The microphone is for receiving a voice command to generate a voice signal. The controller is disposed in the housing for enabling the microphone when the angle is within a predetermined range and generating a first control signal according to the voice signal. The wireless transmitter is for transmitting the first control signal wirelessly.

An embodiment of the present invention discloses a remote control system. The remote control system includes a remote controller and a receiving device. The remote controller includes a housing, a direction sensor, a microphone, a controller, and a wireless transmitter. The direction sensor is for detecting an angle between an axis of the housing and a vertical axis. The microphone is for receiving a voice command to generate a voice signal. The controller is disposed in the housing for enabling the microphone when the angle is within a predetermined range and generating a first control signal according to the voice signal. The wireless transmitter is for transmitting the first control signal wirelessly. The receiving device includes a wireless receiver and a control unit. The wireless receiver is for receiving the first control signal wirelessly. The control unit is for performing a corresponding operation according to the first control signal.

An embodiment of the present invention discloses a control method of a remote controller. The method includes enabling the microphone when an angle between an axis of the housing and a vertical axis is detected to be within a predetermined range, generating a voice signal according to a voice command received by the microphone, generating a first control signal according to the voice signal, and transmitting the first control signal wirelessly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a remote controller according to an embodiment of the present invention.

FIG. 2 is a schematic diagram illustrating a remote control system according to an embodiment of the present invention.

FIG. 3 is a schematic diagram illustrating an angle between an axis of a housing and a vertical axis according to FIG. 1 and FIG. 2.

FIG. 4 is a flowchart illustrating a control method of a remote controller of FIG. 1.

FIG. 5 is another flowchart illustrating a control method of a remote controller of FIG. 1.

### DETAILED DESCRIPTION

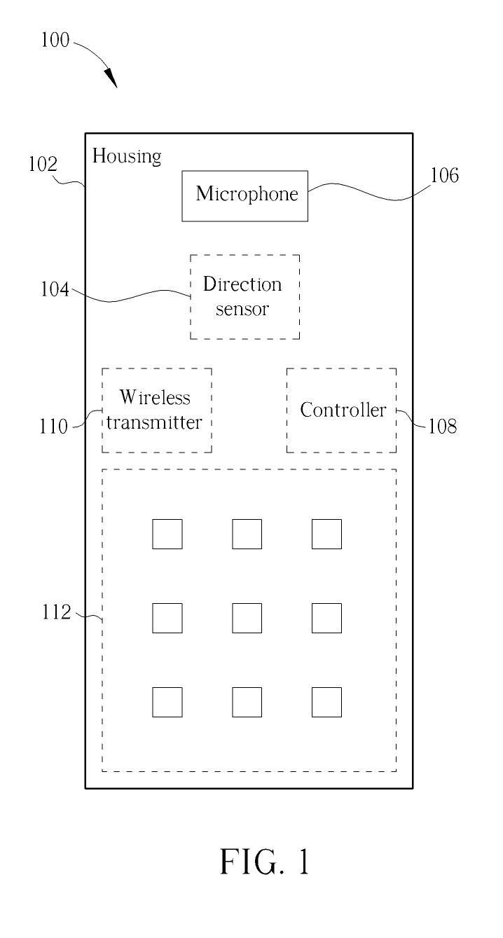

Please refer to FIG. 1. FIG. 1 is a schematic diagram illustrating a remote controller 100 according to an embodiment of the present invention. The remote controller 100 includes a housing 102, a direction sensor 104, a microphone 106, a controller 108, and a wireless transmitter 110. The direction sensor 104 is for detecting an angle between an axis of the housing 102 and a vertical axis. The microphone 106 is for receiving a voice command to generate a voice signal. The controller 108 is disposed in the housing for enabling the microphone 106 when the angle is within a predetermined range and generating a first control signal according to the voice signal. The wireless transmitter 110 is for transmitting the first control signal wirelessly.

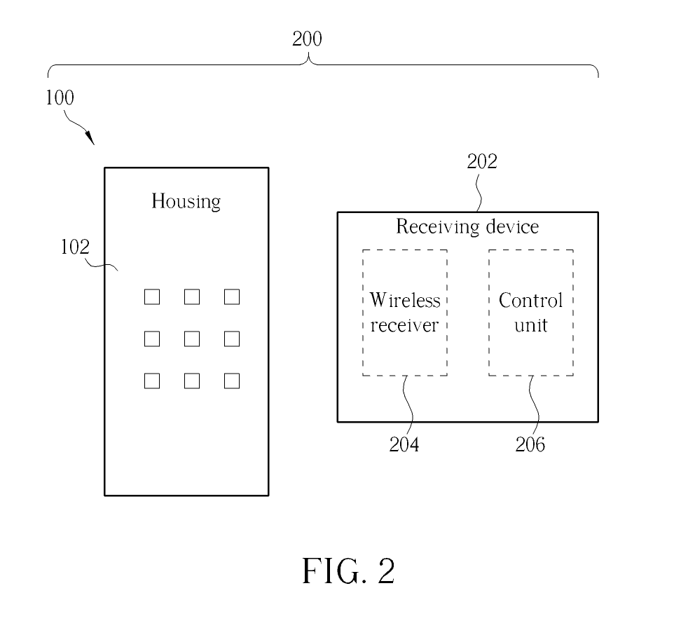

Please refer to FIG. 2. FIG. 2 is a schematic diagram illustrating a remote control system 200 according to an embodiment of the present invention. The remote control system 200 includes the remote controller 100 of FIG. 1 and a receiving device 202. The receiving device 202 includes a wireless receiver 204 and a control unit 206. The wireless receiver 204 is for receiving the first control signal wirelessly. The control unit 206 is for performing a corresponding operation according to the first control signal.

Please refer to FIG. 1 and FIG. 2. In FIG. 1 and FIG. 2, the remote controller 100 may further include a plurality of keys 112 disposed on the housing 102. The plurality of keys 112 is for generating a key signal. The controller 108 may further generate a second control signal according to the key signal. The wireless transmitter 110 may further transmit the second control signal wirelessly. The wireless transmitter 110 may include an omnidirectional wireless transmitter, such as, inter alia, Wi-Fi (wireless fidelity), Bluetooth, and RF (radio frequency) transmitter. The wireless transmitter 110 may also include an infrared transmitter. The direction sensor 104 may include an acceleration sensor, an angular sensor and/or a gyroscope. The remote controller 100 may further include a wireless receiver for receiving wireless signals from other devices so as to perform a data exchange function as a mobile phone does.

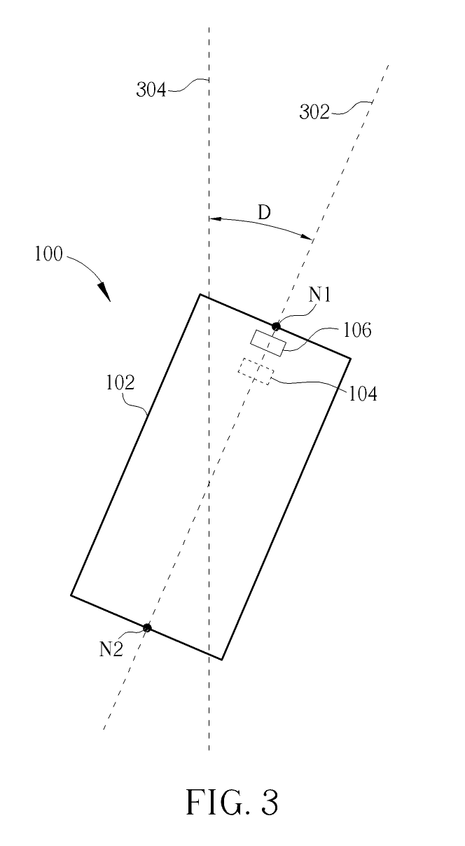

Please refer to FIG. 3 that is a schematic diagram illustrating an angle D between the axis of the housing 102 and the vertical axis according to FIG. 1 and FIG. 2. In FIG. 3, the housing 102 has a first end N1 at which the microphone 106 is disposed and a second end N2 opposed to the first end N1. The axis of the housing 102 is a first axis 302 extending from the first end N1 to the second end N2. The vertical axis is a second axis 304 which is formed by drawing a line from the first end N1 along a direction of the gravity of earth representing a line vertical to a horizontal plane. In FIG. 1 and FIG. 2, the direction sensor 104 of the remote controller 100 may be utilized to detect the angle D between the axis of the housing 102 (the first axis 302) and the vertical axis (the second axis 304).

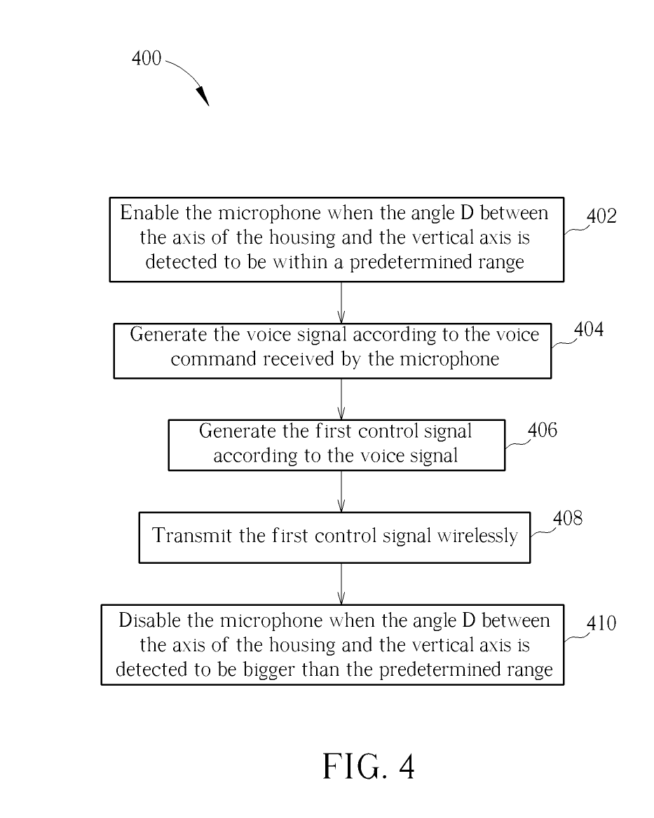

Please refer to FIG. 1, FIG. 3, and FIG. 4. FIG. 4 is a flowchart illustrating a control method 400 of the remote controller 100 of FIG. 1. The control method 400 maybe used in embodiments of the remote controller 100 having or not having the plurality of keys 112. The control method 400 includes:

Step 402: Enable the microphone 106 when the angle D between the axis of the housing 102 and the vertical axis is detected to be within a predetermined range;

Step 404: Generate the voice signal according to the voice command received by the microphone 106;

Step 406: Generate the first control signal according to the voice signal;

Step 408: Transmit the first control signal wirelessly;

Step 410: Disable the microphone 106 when the angle D between the axis of the housing 102 and the vertical axis is detected to be bigger than the predetermined range.

Step 402 maybe implemented by setting the predetermined range of the angle D to be thirty degrees thus when the angle D between the first axis 302 and the second axis 304 is detected to be within thirty degrees for a predetermined duration, the microphone 106 is enabled. In step 408, transmitting the first control signal wirelessly may be transmitting the first control signal via infrared, and transmitting the first control signal wirelessly may also be transmitting the first control signal omnidirectinally. Instep 410, the microphone 106 maybe disabled when the angle D between the first axis 302 and the second axis 304 is detected to be bigger than thirty degrees for a predetermined duration. The microphone 106 may be enabled in step 402 or disabled in step 410 as soon as the angle D between the first axis 302 and the second axis 304 is detected to be within or bigger than thirty degrees respectively without waiting for the predetermined duration.

In another embodiment, when the remote controller 100 lies on a table parallel to the horizontal plane, the angle D between the axis of the housing 102 and the vertical axis is ninety degrees and the microphone 106 is not enabled. The microphone 106 will be enabled when a user picks up the remote controller 100 to make the angle D between the axis of the housing 102 and the vertical axis within thirty degrees.

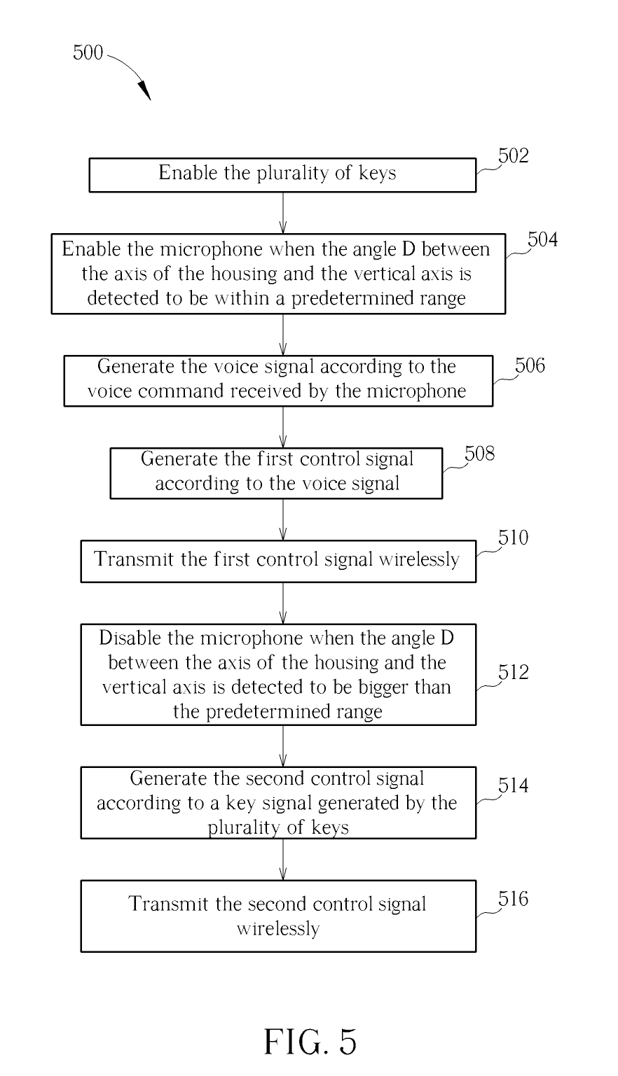

Please refer to FIG. 1, FIG. 3, and FIG. 5. FIG. 5 is another flowchart illustrating a control method 500 of the remote controller 100 of FIG. 1. The control method 500 may be used in an embodiment of the remote controller 100 having the plurality of keys 112. The control method 500 includes:

Step 502: Enable the plurality of keys 112;

Step 504: Enable the microphone 106 when the angle D between the axis of the housing 102 and the vertical axis is detected to be within a predetermined range;

Step 506: Generate the voice signal according to the voice command received by the microphone 106;

Step 508: Generate the first control signal according to the voice signal;

Step 510: Transmit the first control signal wirelessly;

Step 512: Disable the microphone 106 when the angle D between the axis of the housing 102 and the vertical axis is detected to be bigger than the predetermined range.

Step 514: Generate the second control signal according to a key signal generated by the plurality of keys 112;

Step 516: Transmit the second control signal wirelessly.

In step 502, the microphone 106 may be disabled when the plurality of keys is enabled. Step 504 may be implemented by setting the predetermined range of the angle D to be thirty degrees thus when the angle D between the first axis 302 and the second axis 304 is detected to be within thirty degrees for a predetermined duration, the microphone 106 is enabled and the plurality of keys 112 may be disabled. In step 510, transmitting the first control signal wirelessly may be transmitting the first control signal via infrared, and transmitting the first control signal wirelessly may also be transmitting the first control signal omnidirectinally. In step 512, the microphone 106 may be disabled and the plurality of keys 112 may be enabled when the angle D between the first axis 302 and the second axis 304 is detected to be bigger than thirty degrees for a predetermined duration. In step 516, transmitting the second control signal wirelessly may be transmitting the second control signal via infrared, and transmitting the second control signal wirelessly may also be transmitting the second control signal omnidirectinally. The microphone 106 may be enabled in step 504 or disabled in step 512 as soon as the angle D between the first axis 302 and the second axis 304 is detected to be within or bigger than thirty degrees respectively without waiting for the predetermined duration.

In control method 500, the microphone 106 is enabled and the plurality of keys 112 is disabled when the angle D between the housing 102 and the vertical axis is within the predetermined range. When the angle D between the housing 102 and the vertical axis is bigger than the predetermined range, the plurality of keys 112 is enabled and the microphone 106 is disabled. In another embodiment, when the angle D between the housing 102 and the vertical axis is within the predetermined range, the microphone 106 and the plurality of keys 112 may be alternately enabled by adjusting a working duty cycle so that the controller 108 may generate the first control signal or the second control signal according to the voice signal or the key signal respectively. When the angle D between the housing 102 and the vertical axis is bigger than the predetermined range, the plurality of keys 112 is enabled and the microphone 106 is disabled.

In still another embodiment, when the remote controller 100 lies on a table parallel to the horizontal plane, the angle D between the axis of the housing 102 and the vertical axis is ninety degrees and the plurality of keys is enabled so that the key signal and the second control signal may be generated whereas the microphone 106 is disabled. When a user picks up the remote controller 100 to make the angle D between the axis of the housing 102 and the vertical axis within thirty degrees, the microphone 106 will be enabled.

In summary, a voice control mode is implemented in the remote controller of the present invention. By detecting an orientation of the remote controller, the voice control mode may be enabled or disabled. Users may active the voice control mode and send voice command to the remote controller by positioning the remote controller to a predetermined orientation intuitively and thereby eliminating other unnecessary operations to activate the voice control mode. In one way, implementing the voice control mode in the remote controller may reduce the probability that users may press wrong keys and send incorrect commands to the remote controller. In another way, implementing the voice control mode in the remote controller may reduce the amount of keys required to be disposed on the remote controller so as to greatly facilitate usage and operability of remote controller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A remote controller comprising:
a housing;
a direction sensor for detecting an angle between an axis of the housing and a vertical axis;
a microphone for receiving a voice command to generate a voice signal;
a controller disposed in the housing for enabling the microphone when the angle is within a predetermined range and generating a first control signal according to the voice signal; and
a wireless transmitter for transmitting the first control signal wirelessly.

2. The remote controller of claim 1 wherein the wireless transmitter comprises an omnidirectional wireless transmitter.

3. The remote controller of claim 1 wherein the wireless transmitter comprises an infrared transmitter.

4. The remote controller of claim 1 further comprising a plurality of keys disposed on the housing for generating a key signal, wherein the controller further generates a second control signal according to the key signal and the wireless transmitter further transmits the second control signal wirelessly.

5. The remote controller of claim 1 further comprising a wireless receiver for receiving wireless signals.

6. The remote controller of claim 1 wherein the microphone is disposed at a first end of the housing and the direction sensor is for detecting an angle between an axis from the first end to a second end of the housing opposing the first end and the vertical axis.

7. A remote control system comprising:
a remote controller comprising:
a housing;
a direction sensor for detecting an angle between an axis of the housing and a vertical axis;
a microphone for receiving a voice command to generate a voice signal;
a controller disposed in the housing for enabling the microphone when the angle is within a predetermined range and generating a first control signal according to the voice signal; and
a wireless transmitter for transmitting the first control signal wirelessly; and
a receiving device comprising:
a wireless receiver for receiving the first control signal wirelessly; and
a control unit for performing a corresponding operation according to the first control signal.

8. The remote control system of claim 7 wherein the wireless transmitter comprises an omnidirectional wireless transmitter and the remote controller further comprises an omnidirectional wireless receiver for receiving wireless signals.

9. The remote control system of claim 7 wherein the wireless transmitter comprises an infrared transmitter.

10. The remote control system of claim 7 wherein the remote controller further comprises a plurality of keys disposed on the housing for generating a key signal where the controller further generates a second control signal according to the key signal and the wireless transmitter further transmits the second control signal wirelessly.

11. The remote control system of claim 7 wherein the microphone is disposed at a first end of the housing and the direction sensor is for detecting an angle between an axis from the first end to a second end of the housing opposing the first end and the vertical axis.

12. A control method of a remote controller, the remote controller comprising a housing and a microphone, the control method comprising:
enabling the microphone when an angle between an axis of the housing and a vertical axis is detected to be within a predetermined range;
generating a voice signal according to a voice command received by the microphone;
generating a first control signal according to the voice signal; and
transmitting the first control signal wirelessly.

13. The control method of claim 12, the microphone being disposed at a first end of the housing, wherein enabling the microphone when the angle between the axis of the housing and the vertical axis is detected to be within a predetermined range is enabling the microphone when an angle between an axis from the first end to a second end of the housing opposing the first end and the vertical axis is detected to be within thirty degrees.

14. The control method of claim 12 wherein transmitting the first control signal wirelessly is transmitting the first control signal via infrared.

15. The control method of claim 12 wherein transmitting the first control signal wirelessly is transmitting the first control signal omnidirectinally.

16. The control method of claim 12, the remote controller further comprising a plurality of keys, the control method further comprising:
enabling the plurality of keys;
generating a second control signal according to a key signal generated by the plurality of keys; and
transmitting the second control signal wirelessly.

17. The control method of claim 16 further comprising:
disabling the plurality of keys when the microphone is enabled; and
disabling the microphone when the plurality of keys is enabled.

18. The control method of claim 17 further comprising disabling the microphone when the angle between the axis of the housing and the vertical axis is detected to be bigger than the predetermined range.

19. The control method of claim 18 wherein disabling the microphone when the angle between the axis of the housing and the vertical axis is detected to be bigger than the predetermined range is disabling the microphone when the angle between the axis of the housing and the vertical axis is detected to be bigger than the predetermined range for a predetermined duration.

20. The control method of claim 19 wherein enabling the microphone when the angle between the axis of the housing and the vertical axis is detected to be within the predetermined range is enabling the microphone when the angle between the axis of the housing and the vertical axis is detected to be within the predetermined range for a predetermined duration.
